(19) United States
(12) Patent Application Publication
(10) Pub. No.: US 2008/0083290 A1
(43) Pub. Date: Apr. 10, 2008

(54) Force Sensing Device

(75) Inventor: Franz Stadler, Langquaid (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT

(21) Appl. No.: 11/632,781

(22) PCT Filed: Jul. 25, 2005
(86) PCT No.: PCT/EP05/53619

§ 371 Date: Jan. 18, 2007

(30) Foreign Application Priority Data
Jul. 23, 2004 (DE) 10 2004 035 982.2

(51) Int. Cl. G01G 19/414; B60R 21/00

(52) U.S. Cl. 73/862.625; 177/136; 177/225; 340/667

(57) ABSTRACT

A force sensing device has a monolithic metal housing with a rigid upper housing part and a rigid lower housing part, which are interconnected via U-shaped spring elements while being movable in a springy manner towards each other along an axis of movement when a force is applied thereto. The spring elements are disposed symmetrically to one another relative to a cross-sectional area that runs parallel to the axis of movement. A deflection sensor is disposed between the upper and lower rigid housing parts for detecting their movement relative to one another. The unitary housing is produced in metal injection molding (MIM) technology.

The invention relates to a force sensing device. The force sensing device has a monolithic metal housing, with rigid top and bottom housing parts, which can be moved in a springy manner in relation to each other. A deflection sensor is accommodated between the two rigid housing parts which can detect the deflection of the two rigid housing parts in relation to each other and can pass it on as an electrical signal.

In the area of occupant protection in motor vehicles it has become ever more important in recent years to match the triggering of occupant restraint means, for example front airbags, side airbags, knee airbags, curtain airbags, etc. where necessary to the vehicle occupants located in the deployment area of the occupant restraint means or even to suppress it entirely, in order on the one hand to save unnecessary subsequent repair costs after an unnecessary actuation for example when a vehicle seat is unoccupied, and on the other hand not to additionally endanger specific groups of people through an unsuitable triggering procedure, for example children or very small adults. It is thus not only important to establish the presence of a person on a vehicle seat, but over and above this even to establish classifying characteristics of the person, for example their body weight. In this context the crash standard FMVSS208 should be mentioned, compliance with which is increasingly demanded of vehicle manufacturers and which defines the classification of a person by weight, in order, in the event of a collision, to adapt the triggering of an occupant restraint means if necessary in a known manner to the person detected.

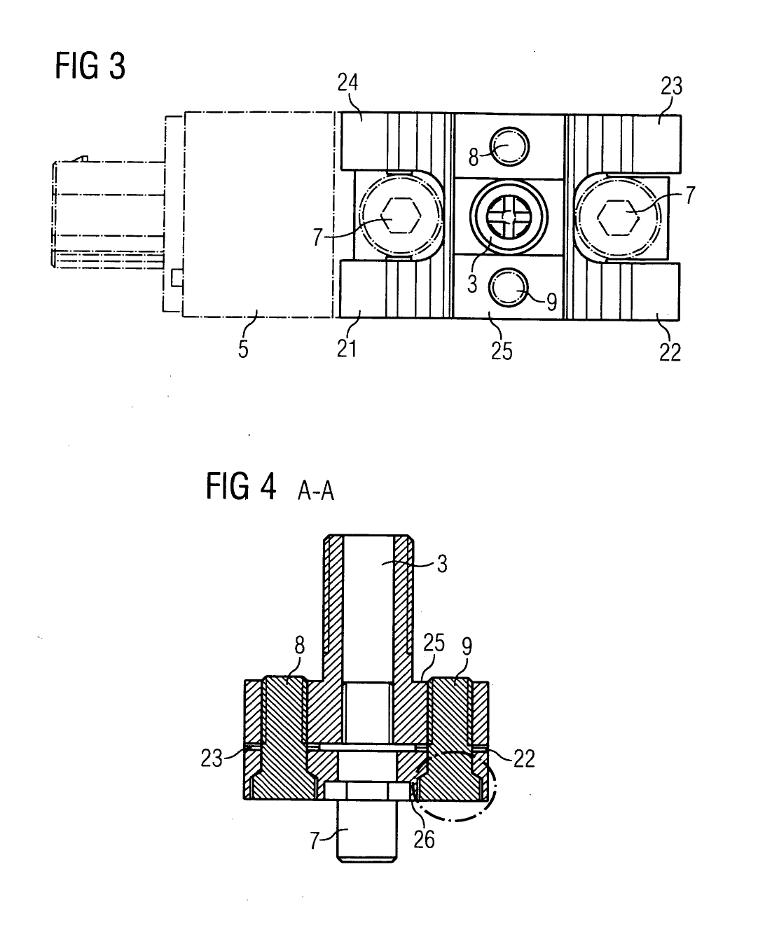

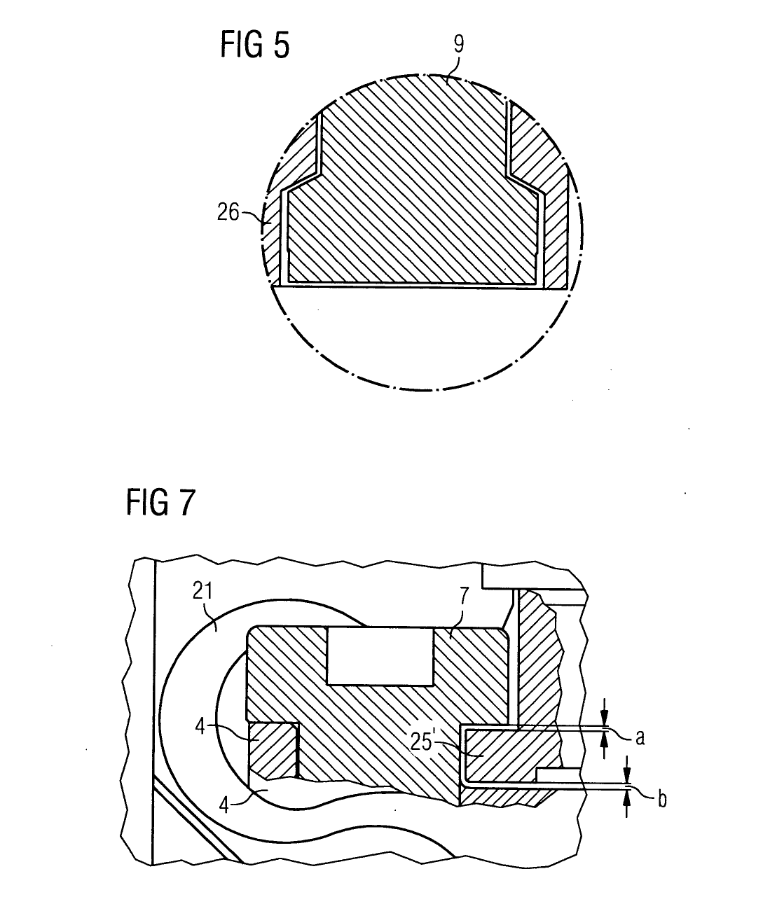

It is known from publication DE 100 04 484, in order to detect the weight of a person on a vehicle seat, to arrange force sensing devices between the vehicle seat and the vehicle chassis. In this case the housing of the force sensing device can be manufactured in one piece and from spring metal, with rigid housing parts (220) and (222) and spring means (232, 234), which connect the rigid housing parts (220, 222) (FIG. 4 and column 8, lines 18 to 27). A deflection sensor is arranged between the two rigid housing parts (220, 222) for example an inductive deflection sensor (190, 192, 194, 196, 198) (FIG. 3), which can determine a deflection of the rigid housing parts (220, 222) and convert it into a measuring signal, which provides information on the force acting on the force sensing device.

The German application DE 101 45 370 A1 discloses a similar force sensing device made of a monolithic metal housing (FIG. 4b and column 6, paragraph [0059]), but with a different sensor principle however.

The known force sensing devices must, in order for them to be able to be usefully employed in a motor vehicle, on the one hand be made very small, to cope with the restricted space between a vehicle seat and the vehicle chassis, and on the other hand they must be extremely stable in shape over the entire lifetime of a motor vehicle, usually at least 15 years, in order where possible to avoid systematic incorrect measurements of the deflection sensor over the course of time. These two demands on the known force sensing devices are however contradictory and appear irreconcilable with each other: A permanently stable housing shape which in the operation of a motor vehicle resists very large weight loads of up to 1.2 t, requires a very massive and rather large housing for the force sensing device. However an installation small space requires a filigree small housing.

The object of the present invention is to create a force sensing device with a permanently stable housing shape as free of hysteresis as possible, which is simultaneously very small and can be easily manufactured.

The object is achieved by a force sensing device as claimed in claim 1.

Advantageous embodiments are specified in the subclaims, whereby any sensible combination of features of the subclaims and the main claim is to be afforded protection.

The inventive force sensing device comprises a monolithic metal housing. The housing comprises a top rigid housing part and a bottom rigid housing part connected to each other via U-shaped spring elements and which can be moved in a springy manner towards each other along an axis of movement when a force is applied thereto. The spring elements are disposed symmetrically to one another relative to a cross-sectional area that runs parallel to the axis of movement. A deflection sensor is mounted between the top and bottom rigid housing parts in order to detect the relative movement of the two rigid housing parts towards each other. According to the invention the housing is produced with the aid of a Metal Injection Molding (MIM) technique.

The use of MIM technology is only known to date from other technical areas, a typical example here being a publication by Hans Schweiger GmbH, which was available on 3 Mar. 2004 on Internet page http://www.formapulvis.com/index.htm, in which the MIM manufacturing process for different application areas is described.

In MIM technology, also known as powder metal injection molding, a fine metal powder is mixed with primary binders and granulated, producing what is referred to as a feedstock. The feedstock is melted in an injection molding machine and molded in a tool into a molding. After cooling down the components are removed as so-called green parts. Subsequently the binders are expelled from the green parts in an oven. The binderless components are now called brown parts and are subsequently sintered in a high-temperature oven.

MIM technology in this case combines with powder metallurgy the flexibility of plastic injection molding to produce different shapes. The MIM method therefore provides the option of allowing highly-integrated metal parts with complex geometries and to a high level of precision to be produced in large volumes at low cost.

With the MIM method it is therefore possible to produce housing walls with a very exact thicknesses and thereby to achieve very exactly calculated form and thickness progressions in a metal housing of an inventive force sensing device. This enables a very small sprung housing to be produced, so that even at a required maximum rated load of for example 150 kg on the force sensing device, a maximum internal stress of 350 Newton/mm² will not be exceeded at any point in the housing and simultaneously a deflection of the rigid housing parts towards each other of at least 1 μm per kg loading weight is achieved.

In addition the monolithic design of the inventive housing makes it possible to avoid previously complex jointing processes between different components of the housing, which—as a result of the reduced number of jointing edges—enables hysteresis occurrences in the inventive force sensing device to be significantly reduced.

Advantageous embodiments of inventive devices are described in the description of the Figures given below. The Figures show:

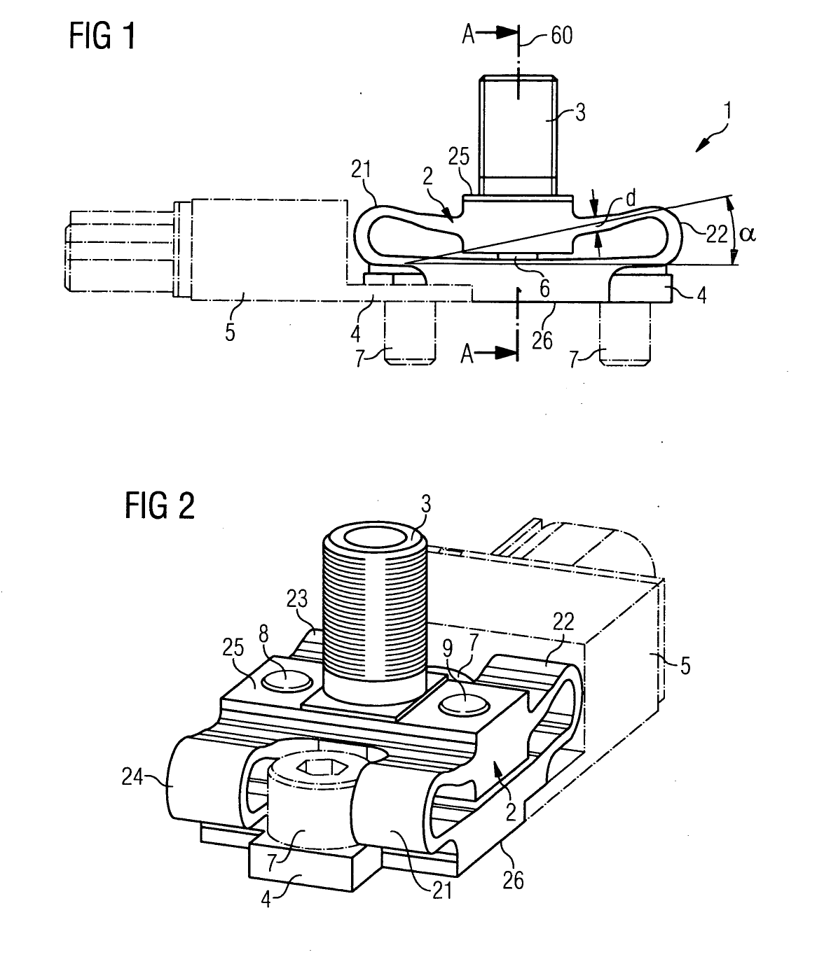

FIG. 1 a first exemplary embodiment for an inventive force sensing device in cross-section,

FIG. 2 the force sensing device depicted in FIG. 1 in a perspective view,

FIG. 3 the force sensing device depicted in FIG. 1 in an overhead view,

FIG. 4 the force sensing device from FIG. 1 in a cross-sectional view along cross section A-A,

FIG. 5 an enlarged part view of FIG. 4

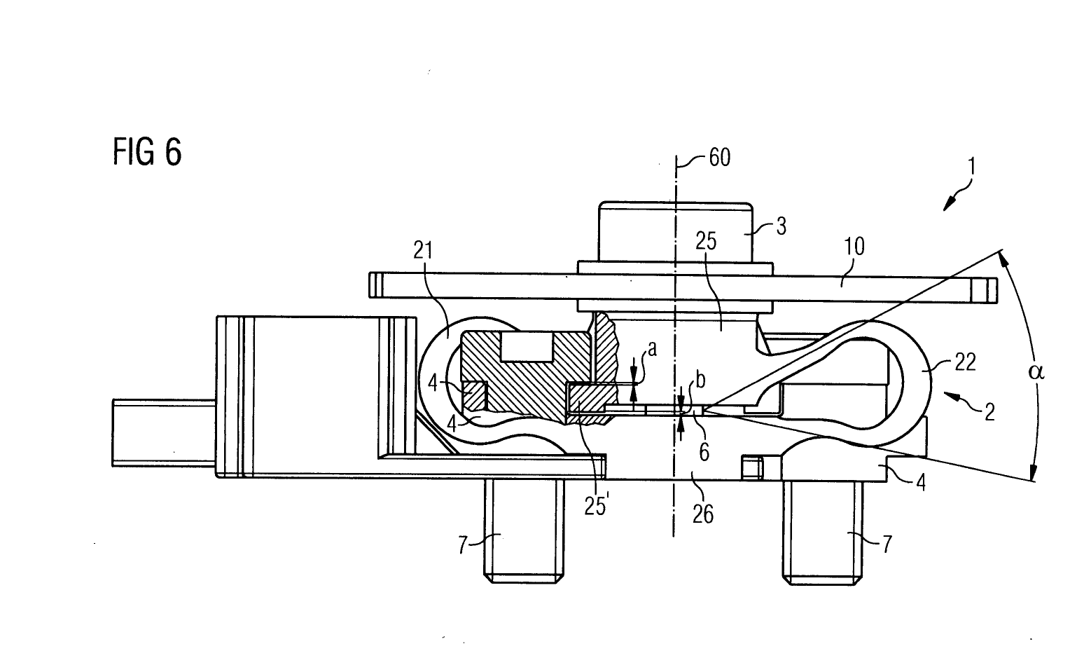

FIG. 6 a second exemplary embodiment for an inventive force sensing device shown in cross section through area A-A as in FIG. 1 and

FIG. 7 an enlarged part section from FIG. 6.

Elements which are constructed or which function in the same way are identified by the same reference symbol in all figures.

FIG. 1 shows an advantageous embodiment of an inventive force sensing device 1, consisting of a monolithic housing 2 produced in Metal Injection Molding (MIM) technology. The housing has a top housing part 25 and a bottom housing part 26, embodied as rigid parts by comparison with the U-shaped spring elements 21 and 22 joining these two housing parts 25, 26 and so that the two rigid housing parts 25 and 26, although they can move towards each other and away from each other under the influence of a weight force, ideally do not themselves deform. A deflection sensor 6 is mounted between the two rigid housing parts 25 and 26, which detects a relative movement of the two housing parts 25, 26 in relation to one another and can convert this into an electrical signal, which is fed via a cable connection not shown via a connector 5 to an electronic evaluation unit or is further processed in the evaluation electronics in the connector 5. This signal is also supplied to an occupant protection device not shown in the diagram and is available there as information about the weight acting on the force sensing device 1, on the basis of which the triggering of an occupant restraint means is adapted if necessary.

In the interests of the desired low mechanical stresses in the housing 22 mentioned at the start, even if a force is acting on it, which is applied by a means of introducing a force 3 from a vehicle seat onto the top rigid housing part 25 and thereby onto the force sensing device 1, the arms of the two spring elements 22 and 21 form an acute angle α.

Furthermore in the interests of a largely even distribution of the stress in the overall housing 2 of the force sensing device 1 each of the spring elements tapers, starting from the top rigid housing part 25 continuously until it reaches a narrowest wall thickness at the beginning of the bend to the U-section. From this point onwards the wall thickness increases again around the bending point of the U-section, reduces again after the bending point and remains constant until the transition into the bottom rigid housing part 26. Since the cross-section A-A represents a plane of symmetry of the spring element, the passage of the wall thickness d along the spring element is the same as that of the spring element 22.

Furthermore the housing 1 shown features, as two integrated components behind each of the two spring bends 21 and 22 shown, an attachment bracket 4 in each case, with the aid of which the force sensing device 1 is connected rigidly in its installed state via two screws 7 to the vehicle chassis. Instead of screws, other means of attachment can also be used, for example rivets or similar.

FIG. 2 shows a perspective view of the force sensing device depicted in FIG. 1. It can be seen that behind the two attachment means 4 with the associated screws 7 there is a further pair of U-shaped spring elements 24 and 25 arranged symmetrically around the two rigid housing parts 25 and 26. This diagram shows particularly clearly how, with the aid of the option of a very filigree embodiment of the housing 2 in MIM technology, the four spring bends shown 21, 22, 23, 24 can be produced narrow enough for the attachment points of the force sensing device 1 to be arranged within the same surface area, which is occupied by the entire housing 2 including spring elements 21, 22, 23 and 24. This surface area is shown once again in FIG. 3 in an overhead view.

FIG. 4 shows a cross-section through the housing 2 of the force sensing device 1 already shown, along cross-section A-A of FIG. 1. The method of operation of the additional overload protection elements 8, 9 will be explained with reference to this cross-sectional diagram, said elements having already been shown in the two FIGS. 2 and 3 in the overhead view of the housing 2. The two overload protection elements 8, 9 are fixed to the top rigid housing part 25, for example by means of a screw connection.

In the direction towards the bottom rigid housing part 26, the diameter of each of the two overload protection elements 8 and 9 increases in steps. The two overload protection elements 8, 9 are each spaced from the bottom rigid housing part 26 by a narrow air gap which remains approximately the same.

To clarify the geometrical design of the two overload protection elements 8, 9, an area of the force sensing device 1 highlighted in FIG. 4 by a black outline is enlarged in FIG. 5.

The two overload protection elements 8 and 9 emerge from the housing 2 as soon as a force acts via the force introduction means 3 in the direction of the bottom rigid housing part 26. A further deflection of the two rigid housing parts 25 and 26 towards one another for a further increase in the force exerted is only prevented if the two overload protection elements 8 and 9 have emerged far enough out of the housing 2 to form a close fit with the motor vehicle chassis.

With a force acting in the reverse direction, the two rigid housing parts 25 and 26 are deflected towards each other, provided the gap between the bottom rigid housing part 26 and the step in each of the two overload protection elements 8, 9 is closed.

FIG. 6 shows a further advantageous embodiment of an inventive force sensing device 1 in a diagram similar to FIG. 1 in cross-section. Unlike in FIG. 1, the top force introduction means 3 is not embodied as a screw with an external thread; instead the top rigid housing part 25 has an internal thread into which the screw is screwed, which is also routed above the top rigid housing part 25 through a cutout of the vehicle seat 10 or of a part rigidly connected with the vehicle seat. In this way the force sensing device 1 is rigidly connected to the vehicle seat 10.

In a further difference from the diagram in FIG. 1, a cross section through one of the two attachment screws 7 is shown. The screw 7 shown in the cross-sectional diagram appears from its highlighted presentation in cross-section to lie in front of spring bend 21; it is however actually arranged behind this bend 21, similar to the other attachment screw 7 shown behind the spring bend 22.

To facilitate understanding of the mechanical design and the subsequent explanation of the advantages produced by this mechanical design, the section through the screw 7 in FIG. 7 is enlarged once again.

A force sensing device 1 in the installed state is shown, meaning that in the present case: Two screws 7 are inserted from the direction of the top rigid housing part 25 through cutouts in the bottom rigid housing part 26 and are screwed to the motor vehicle chassis with their screw thread on the side of the force sensing device 1 facing away from the vehicle seat. In this case, in the exemplary embodiment shown, there is a close-fitting contact surface of a partial area of the screw 7 with the corresponding attachment brackets 4, which are a component of the bottom rigid housing part 26. Instead of a close-fitting contact surface, one or more mechanical stops points can also serve for example to allow a rigid attachment of the force sensing device.

The top rigid housing part 25 rests in the installed state of the force sensing device 1 on neither one nor the other attachment means 7 shown, but is held under a force effect to allow movement against the lower rigid housing part 26. As soon as a compression force in the direction of the vehicle chassis or a tension force in the opposite direction (along the movement axis 60) acts on the force sensing device 1 the two housing parts 25 and 26 consequently move towards each other or away from each other from their rest position.

In the advantageous embodiment of the invention in accordance with FIG. 6 a partial area 25′ of the top rigid housing part 25 engages below the head of screw 7, so that the partial area 25′ is arranged between the screw head of the screw 7 and the bottom rigid housing part 26. On the one hand this causes a gap a to be produced in the direction of movement 60 between the screw head of the screw 7 and partial area 25′ engaging below it; On the other hand a further gap b is produced between the underlying partial area 25′ and the bottom rigid housing part 26; thirdly a further gap (not indicated) is produced perpendicular to the movement axis 60 between the screw and the partial area 25′.

This arrangement of the partial area 25′ enables force to be applied to the force sensing device 1 in the direction of the movement axis 60 on the one hand until such time as the gap b closes through the deflection of the top rigid housing part 25. This creates a mechanical stop in this direction of deflection which prevents a mechanical overextension of the force sensing device 1. On the other hand a mechanical overload with an extension of the force sensing device 1 directed in the opposite direction is prevented by a mechanical stop of the partial area 25′ on the bottom rigid housing part 26, whereby the gap a is closed. The mechanical stop surface shown here could also be reduced to only one stop point if this appears expedient.

The arrangement of the underlying partial area 25′ in relation to the screw 7 has only been explained as an example with reference to the screw 7 shown in the part cross-section depicted in FIGS. 6 and 7. In the example shown in FIG. 6 there is an arrangement similar to this of a further partial area of the top rigid housing part 25 and a second screw 7 symmetrical to the movement direction axis 60. Such a symmetrical arrangement is to be preferred, since it means that the compression or tension forces act symmetrically on the force sensing device 1. In principle the symmetrical arrangement is consequently to be preferred, however an unsymmetrical arrangement could be selected which has functionally the same effect as the overload protection depicted in FIG. 6.

1-7. (canceled)

8. A force sensing device, comprising:
a metal-injection molded, monolithic metal housing formed with a rigid upper housing part, a rigid lower housing part, and U-shaped spring elements interconnecting said upper and lower housing parts and allowing said upper and lower housing parts to move in a springy manner towards each other along an axis of movement when a force is applied thereto;
said spring elements being disposed symmetrically to one another relative to a cross-sectional area extending parallel to said axis of movement; and
a deflection sensor disposed between said upper and lower housing parts for detecting a relative movement therebetween.

9. The force sensing device according to claim 8, wherein each of said U-shaped spring elements is formed with legs enclosing an acute angle.

10. The force sensing device according to claim 8, wherein said spring elements have a defined wall thickness initially decreasing from a start at said rigid upper housing part, and once more increasing towards an apex of said spring element.

11. The force sensing device according to claim 8, wherein said lower housing part includes at least one attachment bracket for rigidly attaching the force sensing device to a chassis of a motor vehicle.

12. The force sensing device according to claim 11, wherein said attachment bracket is formed to be bolted to the motor vehicle chassis.

13. The force sensing device according to claim 8, wherein said housing includes at least four U-shaped spring elements, with two said spring elements projecting in a common direction from said cross-sectional area in each case.

14. The force sensing device according to claim 13, wherein said lower housing part includes two attachment brackets, respectively disposed between two said spring elements, for rigidly attaching the force sensing device to a chassis of a motor vehicle

15. The force sensing device according to claim 11, wherein said upper housing part is formed with a flange engaging below attachment means attaching said lower housing part to the motor vehicle chassis, such that, with said lower housing part rigidly connected to the motor vehicle chassis and a suitably large tension force acting on said upper housing part, a deflection of said upper and lower housing parts relative to one another is limited.
